(19) United States
(12) Patent Application Publication
(10) Pub. No.: US 2008/0141440 A1
(43) Pub. Date: Jun. 19, 2008

(54) HEADGEAR WITH A PROJECTED DESIGN ELEMENT

(76) Inventor: Philip Anthony Taylor, Columbus, OH (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/943,036

(22) Filed: Nov. 20, 2007

Related U.S. Application Data
(63) Continuation of application No. 29/211,591, filed on Aug. 19, 2004, now Pat. No. D558955.

(51) Int. Cl. A42B 1/00; G09F 3/00

(52) U.S. Cl. 2/209.12; 2/195.1; 2/209.11; 40/329

(57) ABSTRACT

Various embodiments of the invention provide a headgear, such as a hat or visor, that includes a top portion, a sidewall extending downwardly from the top portion, and a design element attached to and spaced apart from the sidewall. The design element has a front surface and a back surface. The back surface of the design element is adjacent, spaced apart from, and co-facing the sidewall, and the front surface of the design element faces outwardly from the sidewall. In one embodiment, the design element is spaced apart from the sidewall using one or more rods that project from the sidewall. According to various embodiments, the design element may comprise a logo, one or more letters, one or more words, or one or more numbers.

### CROSS-REFERENCE TO RELATED APPLICATIONS

This application is a continuation of U.S. Design application Ser. No. 29/211,591, filed Aug. 19, 2004, which is hereby incorporated herein in its entirety by reference.

### BACKGROUND OF THE INVENTION

Headgear, such as hats and visors, are available that include two-dimensional artistic design elements, such as the use of colors or embroidered or printed logos. However, a need in the art exists for improved headgear that includes design elements that are more prominently visible and allow for more display options.

### BRIEF SUMMARY OF VARIOUS EMBODIMENTS OF THE INVENTION

Various embodiments of the invention provide a headgear, such as a hat or visor, that includes a top portion, a sidewall extending downwardly from the top portion, and a design element attached to and spaced apart from the sidewall. The design element has a front surface and a back surface. The back surface of the design element is adjacent and spaced apart from the sidewall, and the front surface of the design element faces outwardly from the sidewall. In one embodiment, the design element is spaced apart from the sidewall such that at least a portion of the back surface of the design element is visible to an observer of the headgear. In another embodiment, the design element is spaced apart from the sidewall using one or more rods that project from the sidewall. According to various embodiments, the design element may comprise, consist essentially of, or consist of a logo, one or more letters, one or more words, or one or more numbers, for example.

In a particular embodiment of the invention, the headgear includes a first design element that is attached to and spaced apart from the sidewall and a second design element that is attached to the headgear. The first design element is positioned substantially adjacent to and spaced apart from the second design element.

### BRIEF DESCRIPTION OF THE DRAWINGS

Having thus described the invention in general terms, reference will now be made to the accompanying drawings, which are not necessarily drawn to scale, and wherein:

FIG. 1 illustrates a side view of a hat according to one embodiment of the invention.

FIG. 2 illustrates a front perspective view of the hat shown in FIG. 1.

FIG. 3 illustrates a top view of the hat shown in FIG. 1.

FIG. 4 illustrates a front perspective view of the hat shown in FIG. 1.

FIG. 5 illustrates a front perspective view of a hat according to another embodiment of the invention.

FIG. 6 illustrates a front perspective view of a hat according to yet another embodiment of the invention.

FIG. 7 illustrates a front perspective view of a hat according to another embodiment of the invention.

FIG. 8 illustrates a cross sectional view of the hat of FIGS. 1 and 2, taken through the A-A line shown in FIG. 2.

### DETAILED DESCRIPTION OF VARIOUS EMBODIMENTS OF THE INVENTION

Various embodiments of the present invention now will be described more fully with reference to the accompanying drawings, in which some, but not all embodiments of the invention are shown. Indeed, various embodiments of this invention may be embodied in many different forms and should not be construed as limited to the embodiments set forth herein. Like numbers refer to like elements throughout.

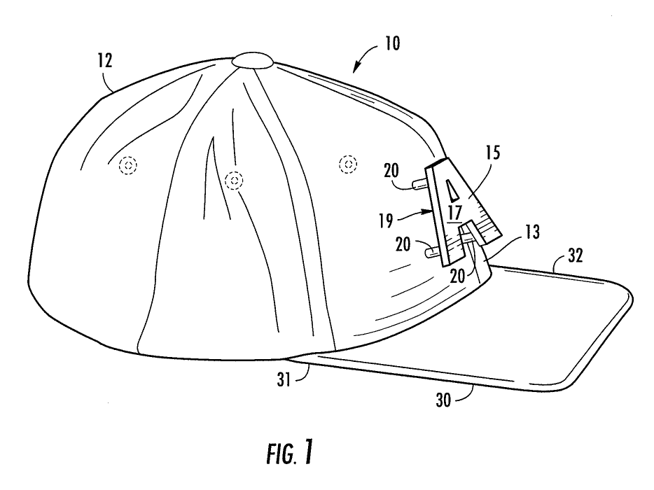

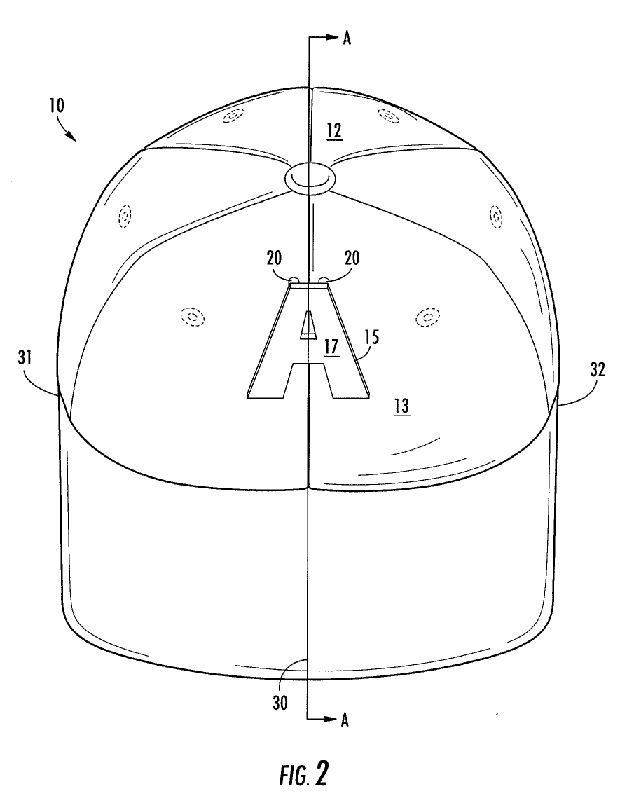

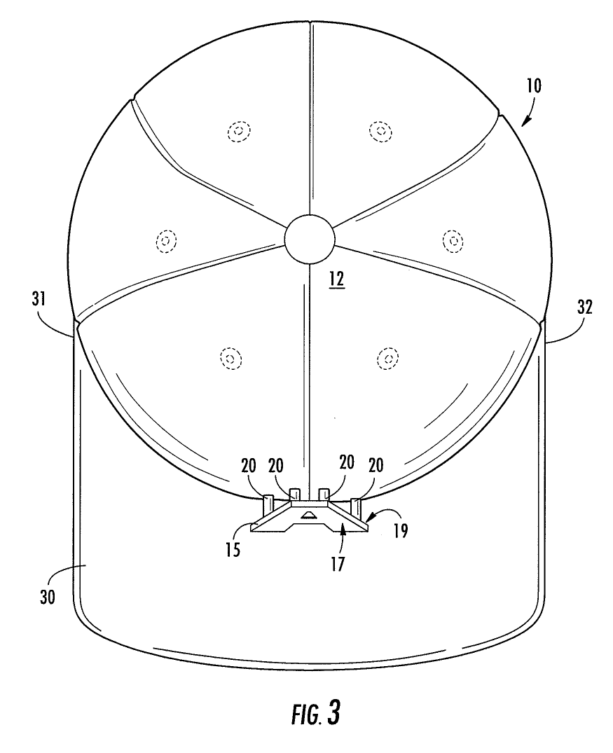

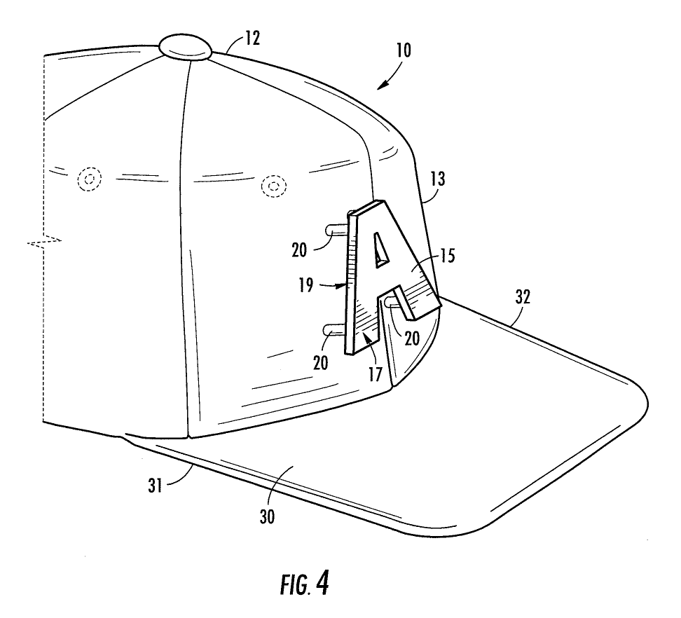

As shown in FIGS. 1-4, a hat 10 according to various embodiments of the invention includes a top portion 12, a sidewall 13 (which may, for example, be a substantially vertical sidewall) extending downwardly from the top portion 12, and a design element 15 attached to and spaced apart from the hat's sidewall 13 (e.g., via one or more connecting rods). According to various embodiments, the design element 15 appears to protrude from the sidewall 13 of the hat 10. In particular embodiments, the design element 15 has a front surface 17 and a back surface 19. The back surface 19 of the design element 15 is adjacent, spaced apart from, and co-facing the hat's sidewall 13, and the front surface 17 of the design element 15 faces outwardly from the hat's sidewall 13. In an embodiment in which the headgear is a visor, the headgear does not include a top portion, but does include a sidewall that extends substantially circumferentially around a wearer's head.

In various embodiments, the design element 15 is spaced apart from the sidewall between about ⅛ inch and about 1 inch. In a particular embodiment, the design element 15 is spaced apart from the sidewall 13 about 3/16 inch.

In the particular embodiment shown in FIGS. 1 through 4, the design element 15 is spaced apart from the sidewall 13 using one or more rods 20 that project from the sidewall 13. According to various embodiments, the rods 20 may be made of metal, plastic or other suitable material. In one embodiment, the rods 20 are made of a substantially transparent material, such as clear plastic or glass, such that the design element has the appearance of floating in front of the sidewall 13 of the hat 10. In other embodiments, the rods 20 may be opaque or colorful.

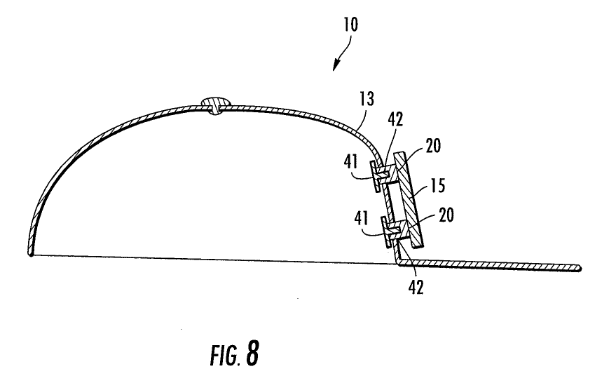

In addition, according to various embodiments of the invention, each rod may define a hollow portion that is adapted for receiving a fastener to secure the rod to the sidewall 13. For example, in the embodiment shown in FIG. 8, a screw 41 is engaged into a threaded hollow portion 42 of each rod 20 to secure the rod 20 to the sidewall 13 of the hat 10. Furthermore, in the embodiment shown in FIG. 8, the rods 20 extend from an interior portion 31 of the hat 10 through the sidewall 13 to an exterior portion 32 of the hat 10 and are attached to the design element 15.

According to one embodiment, which is shown in FIGS. 1 through 4, the hat 10 includes a brim (or bill) 30 along a front portion of the sidewall 13 of the hat 10. In the embodiment shown in FIGS. 1 through 4, the design element 15 is positioned between the lateral edges 31, 32 of the brim 30. In this embodiment, the design element 15 is visible to an observer of the hat 10 looking at the front of the hat 10. In one embodiment, the design element 15 is positioned above the brim 30 and does not touch it. However, in various other embodiments, at least a portion of the design element 15 may be positioned to contact the brim 30. In addition, in various alternative embodiments of the invention (not shown), the design element 15 may be disposed adjacent a back portion of the sidewall 13 of the hat 10 such that an observer of the hat 10 would see the front surface 17 of the design element 15 when viewing the back of the hat 10.

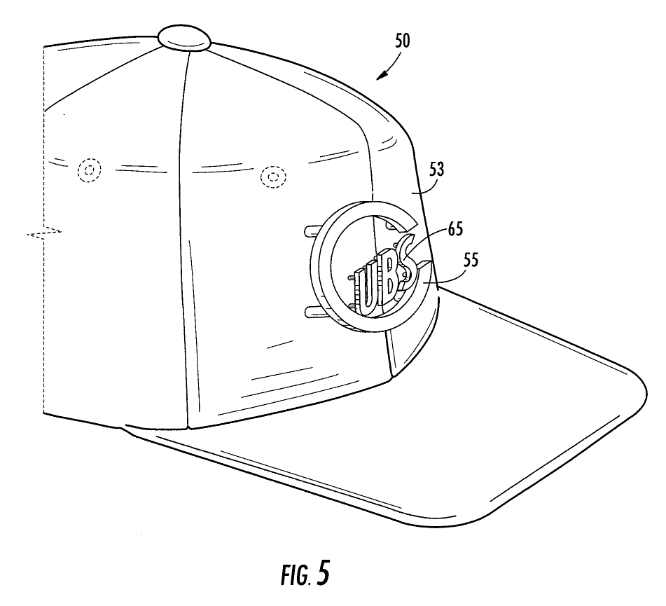

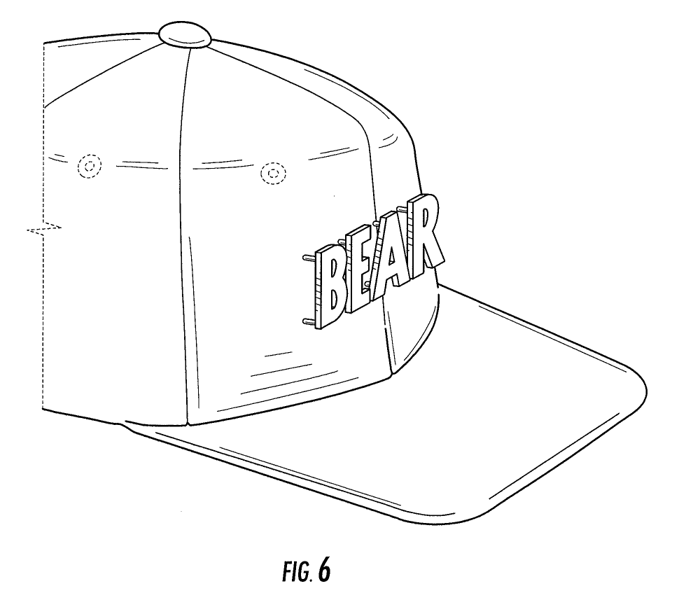

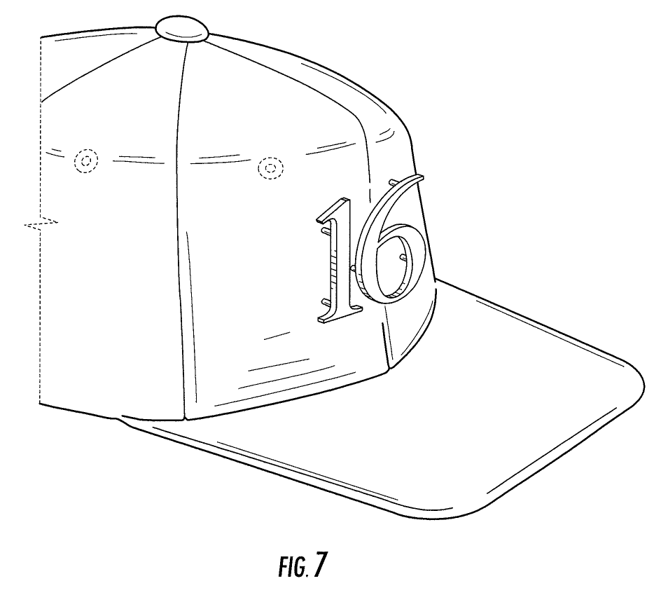

According to various embodiments, the design element 15 may comprise, consist essentially of, or consist of a logo or icon (such as shown in FIG. 5), one or more letters (such as shown in FIGS. 1-4), one or more words (such as shown in FIG. 6), or one or more numbers (such as shown in FIG. 7), for example. In addition, the design element 15 may be curved to generally correspond with a curvature of the hat's sidewall 13 adjacent the design element 15. According to a particular embodiment, which is shown in FIG. 5, the hat 50 further includes a second design element 65 that is embroidered or otherwise attached adjacent (e.g., to) the surface of the hat's sidewall 53, and the first design element 55 is positioned adjacent to and spaced apart from the second design element 65. For example, the first design element 55 may be the styled “C” logo used for the Chicago Cubs and the second design element 65 may be the letters “ubs” such that the combination of the design element 55 and the second design element 65 spell “Cubs”. Accordingly, the first and second design elements 55, 65 may cooperate to form a single word that comprises one or more letters that are spaced apart from the hat's sidewall 13, and one or more letters that are not spaced apart from the hat's sidewall 13.

It should be understood that although a baseball-style hat is shown in FIGS. 1-7, the design element may be provided on (e.g., on the sidewall of) any type of headgear, such as, for example, batting helmets, visors, toboggans, or bucket hats.

In one embodiment, such as the embodiment shown in FIGS. 1-4, the design element 15 is spaced apart from the hat's sidewall 13 such that at least a portion of the back surface 19 of the design element 15 is visible to an observer of the hat 10 (e.g., due to the spacing between the back surface 19 of the design element 15 and the hat's sidewall 13). According to an alternative embodiment (not shown), the back surface 19 of the design element 15 may include a message that is part of or separate from the message conveyed by the front surface of the design element. For example, the front surface may include the word “Florida” and the back surface may include the word “Marlins”.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended listing of inventive concepts. Although specific terms are employed herein, they are used in a generic and descriptive sense only and not for purposes of limitation.

1. A headgear comprising:
a top portion;
a sidewall extending downwardly from said top portion; and
a design element attached to and spaced apart from said sidewall,
wherein said design element has a front surface and a back surface, said back surface being adjacent and spaced apart from said sidewall and said front surface facing outwardly from said sidewall.

2. The headgear of claim 1, wherein said design element is spaced apart from said sidewall such that at least a portion of said back surface of said design element is visible to an observer of said headgear due to spacing between said back surface of said design element and said hat's sidewall.

3. The headgear of claim 1, wherein said design element is spaced apart from said sidewall by between about ⅛ inches and about 1 inch.

4. The headgear of claim 3, wherein said headgear further comprises one or more rods, said one or more rods being disposed between said design element and said sidewall such that said design element is spaced apart from said sidewall.

5. The headgear of claim 4, wherein said one or more rods attach said design element to said sidewall of said headgear.

6. The headgear of claim 4, wherein each of said one or more rods comprises a first end and a second end, said first end disposed adjacent said sidewall and said second end disposed adjacent said back surface of said design element.

7. The headgear of claim 4, wherein each of said one or more rods comprises a hollow portion configured for receiving a fastener to attach each of said one or more rods to said sidewall.

8. The headgear of claim 4, wherein said one or more rods are substantially transparent.

9. The headgear of claim 4, wherein said one or more rods are substantially opaque.

10. The headgear of claim 4, wherein said one or more rods extend through said sidewall and are attached to said design element.

11. The headgear of claim 1, wherein said design element is spaced apart from said sidewall using one or more rods projecting from said sidewall.

12. The headgear of claim 1, wherein said design element is a first design element and a second design element is attached to said headgear, and wherein said first design element is disposed substantially adjacent to and spaced apart from said second design element.

13. The headgear of claim 12, wherein said first design element and said second design element cooperate to form a single word, said single word comprising one or more letters that are spaced apart from said sidewall and one or more letters that are not spaced apart from said sidewall.

14. The headgear of claim 1, wherein:
said headgear further comprises a brim attached to said headgear, said brim comprising a first lateral edge and a second lateral edge that is spaced apart from said first lateral edge, and
said design element is disposed substantially between said first and second lateral edges of said brim.

15. The headgear of claim 1, wherein said design element comprises a logo.

16. The headgear of claim 1, wherein said design element comprises one or more letters.

17. The headgear of claim 1, wherein said design element comprises one or more words.

18. The headgear of claim 1, wherein said design element comprises one or more numbers.

19. A visor for wearing on a wearer's head, said visor comprising:
a sidewall adapted for fitting substantially circumferentially around said wearer's head; and
a design element attached to and spaced apart from said sidewall,
wherein said design element has a front surface and a back surface, said back surface being adjacent and spaced apart from said sidewall and said front surface facing outwardly from said sidewall.
